(19) United States
(12) Patent Application Publication
(10) Pub. No.: US 2021/0024101 A1
(43) Pub. Date: Jan. 28, 2021

(54) AUTONOMOUS DRIVING DEVICE

(71) Applicant: KABUSHIKI KAISHA TOKAI RIKA DENKI SEISAKUSHO, Aichi (JP)

(72) Inventors: Tomoya Yoshida, Aichi (JP); Seiji Kondo, Aichi (JP); Toru Koshimizu, Aichi (JP); Takehiro Watanabe, Aichi (JP); Muneyoshi Kakimi, Aichi (JP); Seiji Ishigaki, Aichi (JP)

(21) Appl. No.: 16/932,384

(22) Filed: Jul. 17, 2020

(30) Foreign Application Priority Data
Jul. 25, 2019 (JP) 2019-136872

(51) Int. Cl. B60W 60/00; G05D 1/00; B60W 50/08; B60W 10/20

(52) U.S. Cl. CPC B60W 60/0054; B60W 60/0057; B60W 10/20; G05D 1/0061; B60W 50/082; B60W 60/0059

(57) ABSTRACT

An autonomous driving device allows for autonomous driving of a vehicle. The autonomous driving device includes a monitoring unit and a switching unit. The monitoring unit monitors an operation state of a driving-system operation device of the vehicle. The switching unit switches a driving mode of the vehicle to manual driving, in which a user drives the vehicle, when the monitoring unit confirms that the driving-system operation device has been operated in accordance with a specified procedure under a condition that a vehicle speed is lower than or equal to a specified value.

### CROSS-REFERENCE TO RELATED APPLICATIONS

This application is based upon and claims the benefit of priority from prior Japanese Patent Application No. 2019-136872, filed on Jul. 25, 2019, the entire contents of which are incorporated herein by reference.

### BACKGROUND

The following description relates to an autonomous driving device that allows for autonomous driving of a vehicle.

### 2. DESCRIPTION OF RELATED ART

Japanese Laid-Open Patent Publication No. 2016-133985 discloses an autonomous driving device that selectively switches a driving mode of a vehicle between manual driving and autonomous driving. In the autonomous driving device, for example, when the vehicle is in the autonomous driving mode, if the driver observes an obstacle on the road and suddenly operates the steering wheel to avoid the obstacle, the vehicle will be switched from autonomous driving to manual driving in order to prevent a collision.

### SUMMARY

In the autonomous driving device, if, for example, a driving-system operation device used for manual driving includes an anomaly when the driving mode of the vehicle is switched from autonomous driving to manual driving, the anomaly may affect driving of the vehicle by the driver. For example, a sensor or the like may be added to the driving-system operation device to detect such an anomaly. However, the addition of such a sensor will increase the number of components.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect, an autonomous driving device is configured to perform autonomous driving with a vehicle. The autonomous driving device includes a monitoring unit and a switching unit. The monitoring unit monitors an operation state of a driving-system operation device of the vehicle. The switching unit switches a driving mode of the vehicle to manual driving, in which a user drives the vehicle, when the monitoring unit confirms that the driving-system operation device has been operated in accordance with a specified procedure under a condition that a vehicle speed is lower than or equal to a specified value.

Other features and aspects will be apparent from the following detailed description, the drawings, and the claims.

### BRIEF DESCRIPTION OF THE DRAWINGS

FIG. 1 is a schematic block diagram illustrating the configuration of an autonomous driving device according to one embodiment.

FIG. 2 is a schematic block diagram illustrating the configuration of a driving-system operation device (steering device) of FIG. 1.

FIG. 3 is a schematic diagram illustrating an example of a user operation performed to switch to manual driving.

FIG. 4 is a flowchart illustrating an example of a control for switching to manual driving.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

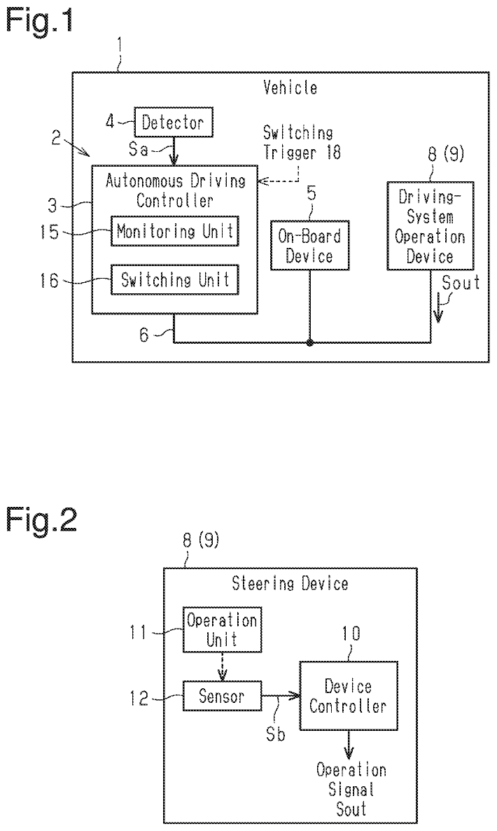

One embodiment of an autonomous driving device will now be described with reference to FIGS. 1 to 4.

As illustrated in FIG. 1, a vehicle 1 includes an autonomous driving device 2 that allows for autonomous driving of the vehicle 1. When autonomous driving is performed, the user does not need to manually drive the vehicle. The vehicle 1 may employ, for example, a steer-by-wire steering system. The autonomous driving device 2 includes an autonomous driving controller 3 that is configured to control the autonomous driving device 2. The autonomous driving controller 3 receives various types of information required for autonomous driving from a detector 4 that detects the traveling environment such as the environment inside and outside the vehicle 1. Further, the autonomous driving controller 3 is, for example, connected to an on-board device 5 via a communication line 6 of the vehicle 1. The communication line 6 may be part of, for example, Controller Area Network (CAN) and/or Local Interconnect Network (LIN).

When a driving mode of the vehicle 1 is set to autonomous driving, the autonomous driving controller 3 receives a detection signal Sa from the detector 4 and controls the on-board device 5 based on the detection signal Sa to perform autonomous driving of the vehicle 1. Examples of events that switch the vehicle 1 to autonomous driving include operation of a switching device, actuation of a sensor, an input to an in-vehicle monitor, a voice input, or detection of a gesture.

The detector 4 includes, for example, a camera, a radar, a lidar, a sonar, a further sensor, or a combination of two or more of said devices. A camera, for example, captures images of the environment around the vehicle 1 and/or inside the vehicle 1. A radar, for example, transmits radio waves such as millimeter waves to the periphery of the vehicle 1 to detect the distance from the vehicle 1 to an object or the direction of the object. A lidar, for example, emits laser light such as infrared light to the periphery of the vehicle 1 to detect the distance from the vehicle 1 to an object. A sonar, for example, detects an object using sound waves. The further sensor may be, for example, a proximity sensor. Examples of the on-board device 5 include a power-steering device, which applies operation force to the steering system of the vehicle 1, and a brake device, which applies braking force to the vehicle 1.

The autonomous driving device 2 has a manual-driving switching function for switching the vehicle 1 from autonomous driving to manual driving. In the present example, the manual driving switching function is a function for switching the driving mode of the vehicle 1 to manual driving when a driving-system operation device 8 arranged in the vehicle 1 is operated in accordance with a specified procedure under the condition that the vehicle speed is lower than or equal to a specified value. Before switching to manual driving, the driving mode of the vehicle 1 may be autonomous driving (autonomous driving mode) or a neutral (neutral mode), in which the vehicle 1 is neither autonomous driving nor manual driving.

As illustrated in FIG. 2, an example of the driving-system operation device 8 is a steering device 9 that is operated to steer the vehicle 1 while the vehicle 1 is traveling. The steering device 9 includes a device controller 10, an operation unit 11, and a sensor 12. The device controller 10 controls operation of the steering device 9. The sensor 12 detects an operation amount of the operation unit 11. The steering device 9 is but not limited to, for example, a rotary-type operation device. When the steering device 9 is a rotary-type operation device, the operation unit 11 is, for example, configured to be rotatable in left and right directions from a neutral position. The device controller 10 calculates the operation amount (for example, rotational angle) of the operation unit 11 from the neutral position (initial position) based on a detection signal Sb received from the sensor 12. Then, the device controller 10 outputs the calculated operation amount as an operation signal Sout via the communication line 6 to another electronic control unit (ECU, for example, ECU that controls on-board device 5). In the vehicle 1 including the autonomous driving device 2, a steering wheel may not be provided in front of the driver seat. In such a case, the steering device 9 may be located, for example, at a predetermined position near the driver seat. Alternatively, when a steering wheel is provided in front of the driver seat of the vehicle 1, the steering wheel may serve as the steering device 9.

The driving-system operation device 8 is not limited to the steering device 9 and may be, for example, a brake operation device (e.g., brake pedal) that is operated to generate braking force of the vehicle 1 while the vehicle 1 is traveling. Further, the driving-system operation device 8 may be an acceleration operation device (e.g., accelerator pedal) that is operated to increase or decrease the vehicle speed while the vehicle 1 is traveling.

As illustrated in FIG. 1, the autonomous driving device 2 includes a monitoring unit 15 arranged in the vehicle 1 to monitor an operation state of the driving-system operation device 8. The monitoring unit 15 is arranged in, for example, the autonomous driving controller 3. In the present example, the monitoring unit 15 monitors the operation state of the driving-system operation device 8 based on the operation signal Sout received from the driving-system operation device 8. The monitoring unit 15 monitors the operation state of the driving-system operation device 8 to determine whether the driving-system operation device 8 has been operated in accordance with the specified procedure.

The autonomous driving device 2 includes a switching unit 16 that switches the driving mode of the vehicle 1 between autonomous driving and manual driving. The switching unit 16 is arranged in, for example, the autonomous driving controller 3. The switching unit 16 switches the driving mode of the vehicle 1 to manual driving when the monitoring unit 15 detects that the driving-system operation device 8 has been operated in accordance with the specified procedure under the condition that the vehicle speed is lower than or equal to the specified value. The specified value of the vehicle speed is, for example, 0 km/h, that is, when the vehicle 1 is at standstill (e.g., engine stopped). However, the specified value is not limited to 0 km/h and may be a value greater than zero. In the present example, the switching unit 16 checks whether the vehicle 1 is at standstill to confirm that one condition for permitting switching to manual driving has been satisfied.

Alternatively, the switching unit 16 may check whether a switching trigger 18, which designates switching to manual driving, has been input to confirm that one condition for permitting switching to manual driving has been satisfied. The trigger 18 may be, for example, a switch signal that is received from a manual driving switching device. Further, another example of the trigger 18 is a signal that indicates that a specified conventional switching device of the vehicle 1 has been operated in accordance with the specified procedure.

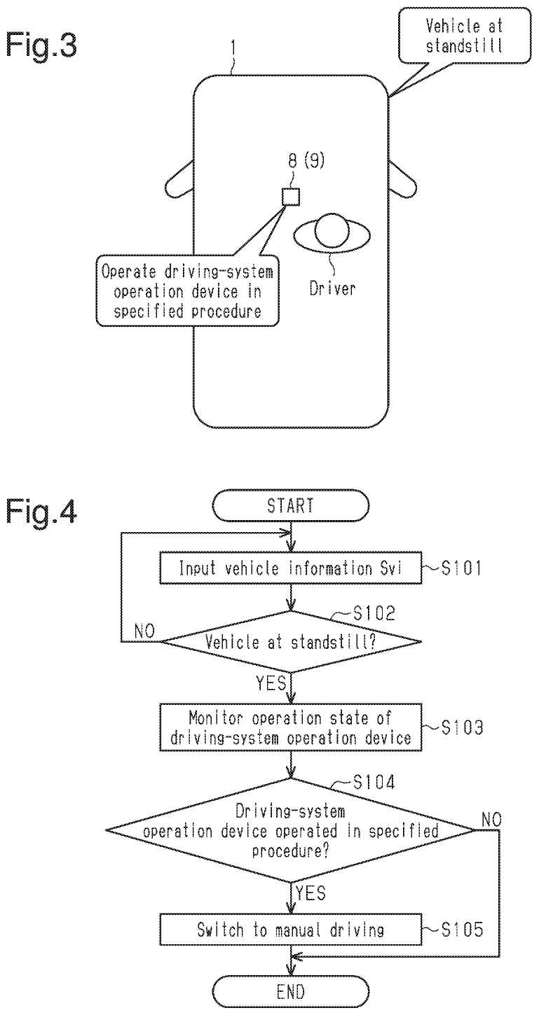

Operation of the autonomous driving device 2 will now be described with reference to FIGS. 3 and 4.

As illustrated in FIG. 3, when driving the vehicle 1 manually, a driver operates the driving-system operation device 8, which is located near the driver seat, in accordance with the specified procedure. When the driving-system operation device 8 is the steering device 9, an operation performed in accordance with the specified procedure includes, for example, rotation of the operation unit 11 of the steering device 9 from the neutral position to each of left and right directions for a specified angle or greater. Alternatively, when the driving-system operation device 8 is an acceleration device, an operation performed in accordance with the specified procedure includes multiple depressions of the accelerator pedal for a specified angle or greater. When the driving-system operation device 8 is a braking device, an operation performed in accordance with the specified procedure includes multiple depressions of the brake pedal for a specified angle or greater.

The driving-system operation device 8 is operated in accordance with the specific procedure when, for example, a user enters the vehicle 1, which is in a parked state (engine stopped, vehicle doors locked), and starts driving the vehicle 1. When, for example, a user wishes to switch to manual driving during autonomous driving, the user may stop the vehicle 1 and operate the driving-system operation device 8 in accordance with the specified procedure.

FIG. 4 illustrates a flowchart that illustrates an example of a control for switching the vehicle 1 to manual driving. In the present example, the flowchart illustrated in FIG. 4 is executed when the trigger 18, which designates switching to manual driving, is input to the autonomous driving device 2 (autonomous driving controller 3). The input of the trigger 18 may be omitted. The trigger 18 may be a signal that is provided to the autonomous driving device 2 in response to, for example, operation of a dedicated switching device, an in-vehicle touch panel, or the like. The driving-system operation device 8 initiates (enables) output of the operation signal Sout when the power source of the vehicle 1 is in an ignition-on state. The vehicle power source is shifted to the ignition-on state, for example, when an engine switch provided near the driver seat is operated.

In step S101, the switching unit 16 inputs vehicle information Svi of a travel state of the vehicle 1. In one example, the switching unit 16 receives vehicle speed information corresponding to the present speed of the vehicle 1 from a meter ECU of the vehicle 1. In addition to or instead of the vehicle speed information, the switching unit 16 receives shift position information corresponding to the present operation position of a transmission from a shift lever device.

In step S102, the switching unit 16 determines whether the vehicle 1 is at standstill based on the vehicle information Svi. This determination is performed to confirm that switching to manual driving is permitted only when the vehicle 1 is at standstill. In a case of the present example, the switching unit 16 determines that the vehicle 1 is at standstill upon receipt of vehicle speed information indicating that the vehicle speed is 0 km/h and shift position information indicating that the shift lever is in a parking position. When the vehicle 1 is at standstill, the autonomous driving controller 3 proceeds to step S103. When the vehicle 1 is not at standstill, that is, when the vehicle 1 is traveling, the autonomous driving controller 3 returns to step S101.

In step S103, the monitoring unit 15 monitors the operation state of the driving-system operation device 8 based on the operation signal Sout received from the driving-system operation device 8. In this manner, the monitoring unit 15 obtains the operation signal Sout of the driving-system operation device 8 and collects information of how the driving-system operation device 8 is being operated from the operation signal Sout. As described above, the driving-system operation device 8 enables output of the operation signal Sout, for example, when the vehicle power source is shifted to the ignition-on state or when a vehicle door is unlocked.

In step S104, the switching unit 16 determines whether the driving-system operation device 8 has been operated in accordance with the specified procedure from the monitoring result of the monitoring unit 15, which indicates the operation state of the driving-system operation device 8. In one example, when the steering device 9 is a rotary-type operation device (e.g., momentary rotary switch), an operation performed in accordance with the specified procedure is, for example, rotation of a knob (operation unit 11) in each of left and right directions from the neutral position for a specified angle or greater. When the driving-system operation device 8 has been operated in accordance with the specified procedure, the autonomous driving controller 3 proceeds to step S105. When the driving-system operation device 8 has not been operated in accordance with the specified procedure, the autonomous driving controller 3 ends the process.

In step S105, the switching unit 16 switches the driving mode of the vehicle 1 to manual driving (manual driving mode). For example, when the present driving mode of the vehicle 1 is autonomous driving, the switching unit 16 switches the driving mode from autonomous driving to manual driving. This allows the user to drive the vehicle 1 manually. After the driving mode of the vehicle 1 is switched to manual driving, the autonomous driving controller 3 ends the process.

The autonomous driving device 2 of the above embodiment has the following advantages.

(1) The autonomous driving device 2 includes the monitoring unit 15 and the switching unit 16. The monitoring unit 15 monitors the operation state of the driving-system operation device 8 of the vehicle 1. When the monitoring unit 15 acknowledges that the driving-system operation device 8 has been operated in accordance with the specified procedure under the condition that the vehicle speed is lower than or equal to the specified value, the switching unit 16 switches the driving mode of the vehicle 1 to manual driving so that the user can drive the vehicle 1.

In this configuration, when the monitoring unit 15 confirms that driving-system operation device 8 has been operated in accordance with the specified procedure, the switching unit 16 acknowledges normal actuation of the driving-system operation device 8. Therefore, the switching unit 16 switches the driving mode of the vehicle 1 to manual driving after acknowledging normal actuation of the driving-system operation device 8. In this manner, the driving-system operation device 8 is checked for an anomaly before switching to manual driving. This restricts switching to manual driving when the driving-system operation device 8 has an anomaly. Thus, safety is ensured for manual driving.

(2) The switching unit 16 checks whether the vehicle 1 is at standstill to confirm that one condition for switching to manual driving has been satisfied. In this configuration, switching to manual driving will not occur unless the vehicle 1 is at standstill. Therefore, switching to manual driving is permitted only when the user is explicitly intends to stop the vehicle 1.

(3) The switching unit 16 checks whether the trigger 18, which designates switching to manual driving, has been input to confirm that one condition for switching to manual driving has been satisfied. The trigger 18 is input when the user operates a switching device or the like. Thus, switching to manual driving is permitted when the user explicitly intends to do so.

(4) The driving-system operation device 8 is a rotary-type operation device including the operation unit 11, which is rotatable. This allows the operation required for the user to perform when switching to manual driving to be a simple rotation operation.

(5) The driving-system operation device 8 is the steering device 9, which is operated to steer the vehicle 1. In this configuration, the switching unit 16 checks whether the steering device 9 has been actuated normally prior to manual driving. Thus, safety of manual driving is further improved.

The above embodiment may be modified as follows. The above embodiment and the following modifications may be combined as long as the combined modifications remain technically consistent with each other.

Driving-System Operation Device 8

The driving-system operation device 8 need not be of a momentary type and may be, for example, of an alternator type.

The driving-system operation device 8 need not be of an automatic reset type and may be of a manual reset type.

The driving-system operation device 8 may be any operation device that is operated while the vehicle 1 is traveling, such as a lever combination switch or a shift lever. Alternatively, the driving-system operation device 8 may be a car navigation system. For example, a switch screen may be provided on a display of the car navigation system, and an operation performed in accordance with the specified procedure may be performed on the screen.

The driving-system operation device 8 is not limited to a conventional device of a vehicle and may be a dedicated device used to switch to manual driving.

The driving-system operation device 8 is not limited to a rotary-type switch and may employ various types of switch devices such as a push switch, a rocker switch, or a slide switch.

The driving-system operation device 8 is not limited to a switch and may be a sensor.

Switching to Manual Driving

The operation of the driving-system operation device 8 in accordance with the specified procedure is not limited to rotation of the operation unit 11 from the neutral position in each of left and right directions and may be, for example, rotation from the neutral position in one of left and right directions.

The operation of the driving-system operation device 8 in accordance with the specified procedure may be, for example, an operation using multiple driving-system operation devices 8.

When operating the driving-system operation device 8, the autonomous driving controller 3 may issue an announcement or a notification to perform the operation performed in accordance with the specified procedure for switching to manual driving.

The operation of the driving-system operation device 8 in accordance with the specified procedures may be variable. In this case, the operation performed in accordance with the specified procedure can be updated periodically, thereby improving security.

A plurality of patterns of the operation of the driving-system operation device 8 in accordance with the specified procedure may be registered, and one of the patterns may be selected and performed.

A time limit may be provided for the operation of the driving-system operation device 8 in accordance with the specified procedure.

The vehicle speed that is less than or equal to the specified value may be a low speed. Therefore, the specified value is not limited to 0 km/h.

Trigger 18 As Designation for Switching to Manual Driving

The trigger 18 may be a signal that is output, for example, when a vehicle door is unlocked.

The trigger 18 may be, for example, a voice input or a gesture.

The trigger 18 may be output when a legitimate authentication information is input to a screen of an in-vehicle car navigation system.

The input of the trigger 18 may be excluded from the condition for permitting switching to manual driving.

Others

The switching unit 16 may check whether a passenger (for example, driver) is present in the vehicle to confirm that one condition for permitting switching to manual driving has been satisfied. For example, the switching unit 16 may check whether the vehicle 1 is at standstill and a passenger is present in the vehicle to confirm that one condition for permitting switching to manual driving has been satisfied. The determination of whether a passenger is present in the vehicle may be performed based on, for example, an output from a seating sensor of a seat, an image captured by a camera, and/or a lock status of the vehicle doors.

In the driving-system operation device 8, a sensor system, which detects an operation of the operation unit 11 for a switching control to manual driving, may be a duplex (redundant) system including two or more sensors 12.

The driving-system operation device 8 may be configured to constantly output the operation signal Sout regardless of the state of the vehicle power source.

The autonomous driving device 2 may be used for a vehicle other than a passenger car.

Computer System

The autonomous driving controller 3 of the present disclosure may be configured as a computer system including one or more processors and a non-transitory memory (non-transitory computer readable storage medium). The non-transitory memory stores instructions (one or more programs) executable by the processors that cause the processors to perform one or more operations (for example, driving switching process including process for switching driving mode of vehicle 1 to manual driving) in accordance with any one of the above embodiments and modified examples. The processors perform the process according to the present disclosure by reading the instructions stored in the non-transitory memory and executing the instructions. The computer system may further include part of the driving-system operation device 8, for example, the device controller 10. Alternatively, some or all of the functions of the autonomous driving controller 3 may be configured by dedicated hardware such as an application specific integrated circuit (ASIC).

Therefore, the present disclosure further includes the following embodiments.

(Embodiment 1) A non-transitory computer readable storage medium that stores instructions executable by one or more processors, the instructions causing the one or more processors to perform a driving switching process for a vehicle, the driving switching process including:

monitoring an operation state of a driving-system operation device of the vehicle;

determining that the driving-system operation device has been operated in accordance with a specified procedure under a condition that a vehicle speed is lower than or equal to a specified value; and in response to the determining, switching a driving mode of the vehicle to manual driving, in which a user drives the vehicle.

(Embodiment 2) A computer system, including:

one or more processors; and

a non-transitory memory that stores instructions executable by the one or more processors, the instructions causing the one or more processors to perform a driving switching process for a vehicle, the driving switching process including:

monitoring an operation state of a driving-system operation device of the vehicle;

determining that the driving-system operation device has been operated in accordance with a specified procedure under a condition that a vehicle speed is lower than or equal to a specified value; and

in response to the determining, switching a driving mode of the vehicle to manual driving, in which a user drives the vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An autonomous driving device that performs autonomous driving with a vehicle, the autonomous driving device comprising:
a monitoring unit that monitors an operation state of a driving-system operation device of the vehicle; and
a switching unit that switches a driving mode of the vehicle to manual driving, in which a user drives the vehicle, when the monitoring unit confirms that the driving-system operation device has been operated in accordance with a specified procedure under a condition that a vehicle speed is lower than or equal to a specified value.

2. The autonomous driving device according to claim 1, wherein the switching unit checks whether the vehicle is at standstill to confirm that one condition for permitting switching to the manual driving has been satisfied.

3. The autonomous driving device according to claim 1, wherein the switching unit checks whether a trigger that designates switching to the manual driving has been input to confirm that one condition for permitting switching to the manual driving has been satisfied.

4. The autonomous driving device according to claim 1, wherein the driving-system operation device is a rotary-type operation device that includes a rotatable operation unit.

5. The autonomous driving device according to claim 4, wherein the driving-system operation device is a steering device that is operated when steering the vehicle.

6. A non-transitory computer readable storage medium that stores instructions executable by one or more processors, the instructions causing the one or more processors to perform a driving switching process for a vehicle, the driving switching process including:
monitoring an operation state of a driving-system operation device of the vehicle;
determining that the driving-system operation device has been operated in accordance with a specified procedure under a condition that a vehicle speed is lower than or equal to a specified value; and
in response to the determining, switching a driving mode of the vehicle to manual driving, in which a user drives the vehicle.
